(19) United States
(12) Patent Application Publication
(10) Pub. No.: US 2026/0072755 A1
(43) Pub. Date: Mar. 12, 2026

(54) WORKLOAD FORECASTING AND PLANNING IN HYBRID MULTI-CLOUD COMPUTING ENVIRONMENTS

(71) Applicant: SAP SE, Walldorf (DE)

(72) Inventors: Asaf Bruner, Ra'anana (IL); Dror Uri, Rishon LeZion (IL)

(21) Appl. No.: 18/828,911

(22) Filed: Sep. 9, 2024

(51) Int. Cl. G06F 9/50

(52) U.S. Cl. CPC G06F 9/5077; G06F 9/5038; G06F 9/5072; G06F 2209/5019; G06F 2209/503

(57) ABSTRACT

A machine learning model is trained to predict short-and long-term resource usage for a user and to take these predictions and forms a provisioning plan for one or more resources, optimized such that resources are started in enough time before they are needed to be used to reduce or eliminate any appreciable delay on the user experience-side but not too much before they are needed that the resource(s) would be idle waiting for usage to occur. If a Gen AI control center is provided that offers a comprehensive user interface displaying the current system state, suggested plans, and prediction quality measures, users can then interact with a chatbot in the Gen AI control center for detailed information on selected plans, and manually add events to anticipate demand spikes. The Gen AI control center is able to create explanatory text and diagrams, improving the understanding of suggested plans.

### TECHNICAL FIELD

This document generally relates to computer systems. More specifically, this document relates to workload forecasting and planning in hybrid multi-cloud computing environments.

### BACKGROUND

In modern large scale computer systems, computing resources are typically utilized either in the cloud (in a distributed manner across many computer systems, away from an organization's own computer systems), on-premises (on the organization's own computer systems), or both (called a hybrid computing environment).

### BRIEF DESCRIPTION OF THE DRAWINGS

The present disclosure is illustrated by way of example and not limitation in the figures of the accompanying drawings, in which like references indicate similar elements.

FIG. 1 is a block diagram illustrating a system for scheduling resource allocation, in accordance with an example embodiment.

FIG. 2 is a sequence diagram illustrating a method for provisioning resources in a networked system, in accordance with an example embodiment.

FIG. 3 is a screen capture showing a first screen of a user interface, in accordance with an example embodiment.

FIG. 4 is a screen capture showing a second screen of the user interface, in accordance with an example embodiment.

FIG. 5 is a screen capture showing a third screen of the user interface, in accordance with an example embodiment.

FIG. 6 is a flow diagram illustrating a method, in accordance with an example embodiment.

FIG. 7 is a block diagram illustrating a software architecture, in accordance with an example embodiment.

FIG. 8 illustrates a diagrammatic representation of a machine in the form of a computer system within which a set of instructions may be executed for causing the machine to perform any one or more of the methodologies discussed herein.

### DETAILED DESCRIPTION

The description that follows discusses illustrative systems, methods, techniques, instruction sequences, and computing machine program products. In the following description, for purposes of explanation, numerous specific details are set forth to provide an understanding of various example embodiments of the present subject matter. It will be evident, however, to those skilled in the art, that various example embodiments of the present subject matter may be practiced without these specific details.

In today's computing environments, there is a need to predict the amount and kind of resources a system needs to handle a changing workload. Additionally, often resources take time to be initialized or otherwise brought to a point where they can start being used, and thus allocating a resource to a system on a completely ad-needed basis (i.e., literally when the user is requesting something that requires use of a resource), can lead to a degraded user experience as the user must wait while the resource is being initialized. Thus, workload prediction is complicated by not only the volume of resources and systems involved, but also by the inherent delay in making those resource available.

Additionally, workloads tend to change over time, sometimes in a fairly regular pattern, but one that can be challenging to detect, such as in accordance with workweek days, holidays, preplanned events, hours of the day, particular workplace culture, and other hard-to-predict patterns.

Hyperscalers are large cloud service providers; part of the delay in initializing resources can be due to hyperscalers'own latency. Procuring resources from hyperscalers involves a significant lead time, and even after allocation, additional time is required to configure and ready the resource for use within the system.

Thus, there is a need to forecast both the short-and the long-term usage patterns of a system. Short-term usage prediction allows for immediate resource allocation for users of the system, while long-term prediction allows for better resource planning and reservation when dealing with Infrastructure-as-a-Service (IaaS) providers.

Overshooting the number of resources being prepared in advance causes a waste of substantial sums of money, while undershooting it creates a poor user experience as the user waits for the resource to be initialized. Thus, there is a need for a system that knows how to communicate with many different IaaS hyperscalers and other hybrid clouds and one that can-prelaunch needed resources just in time which are tailored for the system tenant needs.

Furthermore, different system tenants can be entitled to different types or amounts of resources. For example, a large tenant may have a premium contract and thus is entitled to get several large computing units while another has a basic contract and is only entitled to a single small computing unit.

In an example embodiment, a machine learning model is trained to predict short-and long-term resource usage for a user and to take these predictions and forms a provisioning plan for one or more resources, optimized such that resources are started in enough time before they are needed to be used to reduce or eliminate any appreciable delay on the user experience side but not too much before they are needed that the resource(s) would be idle while waiting for usage to occur.

Additionally, users are typically unwilling to allow an automated process to completely take over the process of forming and implementing a provisioning plan. This is because often the users oversee infrastructure of an entire organization and errors in the provisioning plan can be extremely costly. In an example embodiment, generative artificial intelligence (GAI) technology is leveraged to significantly enhance user interaction, experience, and explainability. For example, if a Gen AI control center is provided that offers a comprehensive user interface displaying the current system state, suggested plans, and prediction quality measures, users can then interact with a chatbot in the Gen AI control center for detailed information on selected plans, and manually add events to anticipate demand spikes. The Gen AI control center is able to create explanatory text and diagrams, improving the understanding of suggested plans. It leverages retrieval augmented generation (RAG) technology to communicate with the machine learning model, using collected data and user-specific documentation. This provides transparency into the ML models'decisions to build trust in the system and lowers the barrier of entry for new users.

Furthermore, in an example embodiment, the use of RAG allows the model to customize the outputs it produces to tailor the response specifically for the user. For example, documents that describe the user's line of business can be uploaded so that a recommendation plan explanation refers to the actual way the system would be used in the user's line of business.

Automated report generation summarizes system performance, prediction accuracy, resource utilization, and other key metrics. These reports can be scheduled or triggered by specific events. The Gen AI Control Center also enables scenario simulation, allowing admins to see the impact of parameter changes on predictions and outcomes. Natural language queries simplify extracting information and performing actions, enhancing the overall user experience.

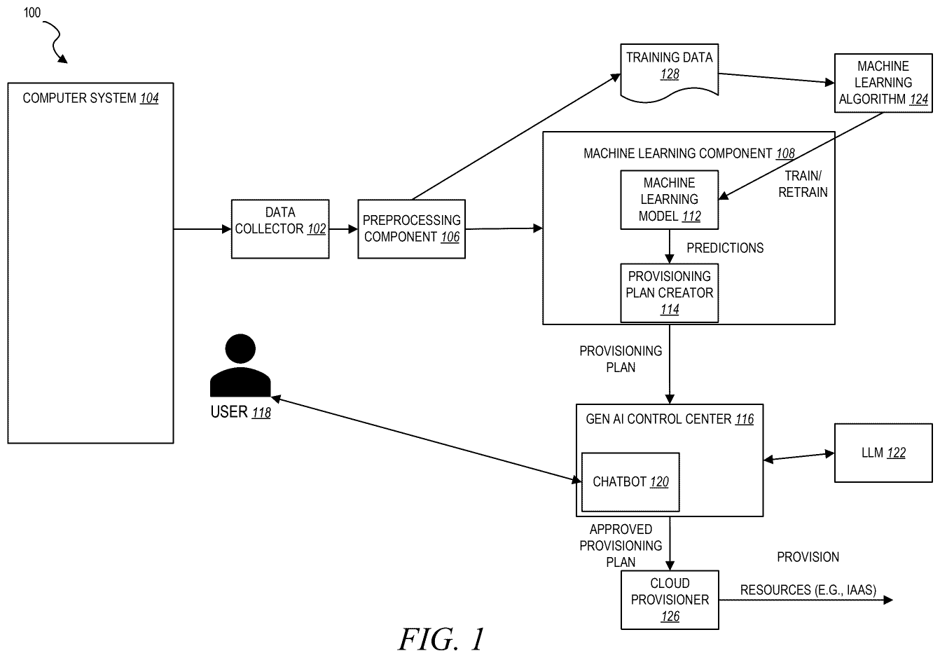

FIG. 1 is a block diagram illustrating a system 100 for scheduling resource allocation, in accordance with an example embodiment. A data collector 102 is responsible for ingesting data from different sources, such as from a computer system 104. This data may include, for example, time series data, tenant-specific data, current system workload, etc. A preprocessing component 106 then normalizes the data.

The normalized data can then be passed to a machine learning component 108. The machine learning component 108 creates a provisioning plan of resources based on the normalized data. More particularly, the machine learning component 108 utilizes a machine learning model 112 that predicts short-and long-term usage patterns of the computer system 104. More precisely, the machine learning model 112 is able to predict usage patterns that are tenant or even user-specific, allowing for a personalized predicted usage pattern. In some instances the machine learning model 112 may be trained specifically for a particular tenant, although in other instances the machine learning model 112 can make tenant-specific predictions for one tenant but still be trained to make tenant-specific predictions for other tenants.

This personalized predicted usage pattern is then utilized by a provisioning plan creator 114 that creates a provisioning plan based on the personalized predicted usage pattern. It should be noted that the provisioning plan creator 114 is depicted here as being separate from the machine learning model 112, but in some example embodiments the provisioning plan creator is coupled to, or even inside, the machine learning model 112.

The provisioning plan is output by the provisioning plan creator 114 to a Gen AI control center 116. The Gen AI control center 116 acts to generate text and images to explain to a user 118 the provisioning plan and its benefits. The user 118 is then able to interact with a chatbot 120 in the Gen AI control center 116 to ask questions and receive generated answers, based on the provisioning plan as well as based on intermediate results computed by the machine learning model 112 and/or provisioning plan creator 114. More particularly, both the machine learning model 112 and the provisioning plan creator 114 can generate intermediate results while they are working through their respective processes (specifically, those processes are predicting short-and long-term usage patterns and generating a provisioning plan, respectively). These intermediate results may be useful to the Gen AI control center 116 in explaining the reasoning behind and/or benefits of the produced provisioning plan.

A large language model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

In an example embodiment, an LLM 122 is accessed by the Gen AI control center 116 to generate the corresponding text and/or images.

LLMs used to generate information are generally referred to as Generative Artificial Intelligence (Gen AI) models. A Gen AI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance.

The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs comprise a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modeling. This contrasts with prior art solutions that looked at a text sequence either from left to right or combined left to right and right to left. A bidirectionally trained language model has a deeper sense of language context and flow than single-direction language models.

More specifically, the transformer encoder reads the entire sequence of information, and thus is considered to be bidirectional (or, alternatively, non-directional). This characteristic allows the model to learn the context of a piece of information based on all its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory) until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, though a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

The present solution works with any type of GAI model, although an implementation that specifically is used with a GPT model will be described.

As previously mentioned, in an example embodiment the GAI control center 116 utilizes RAG to implement the chatbot 120 interactivity, and specifically uses RAG for how the chatbot 120 interacts with the LLM 122 to iteratively refine questions and answers.

RAG makes it possible to answer queries beyond the realm of the LLM training data RAG also assists in reducing the risk of generating fabricated answers. It acts as a sophisticated form of programmatic prompt engineering.

More particularly, in RAG, data is embedded into embeddings. An embedding is a mathematical representation of data in a latent n-dimensional space. In the latent n-dimensional space, embeddings of related data can be close to each other geometrically. Essentially, each embedding is a coordinate in the n-dimensional space and the closer the coordinates of the embedding are to the coordinates of another embedding. Thus, calculating distance between embeddings (typically performed by measuring cosine distance) allows context-based search and text extraction to be performed.

Specifically, the data is first prepared by splitting it into small chunks not exceeding some preset number of tokens. An embedding vector is then generated for each chunk, using an embedding machine learning model that has been trained to know how to embed data of similar subject matter near each other. The embeddings can then be stored in a data store, such as an in-memory database. An in-memory database is a database in which all the data is stored in main memory, as opposed to in volatile memory such as a hard drive.

RAG may therefore be used so that the LLM 112 better understands the system and provides suitable answers to user questions. It can also be used so that the LLM 112 can alert the admin of unusual usage patterns or other abnormalities, and can also interact with observability tools and other interfaces, such as email and messaging interfaces, to send automatic alerts and messages.

When a user query is received via the chatbot 120, the query itself can be embedded using the embedding model. Then a prompt context is built by calculating distances between the query embeddings and the embeddings in the data store. Data having geometrically close embeddings to the query embeddings can then be retrieved and supplied as context with the LLP prompt. This process can be repeated each time a question is asked via the chatbot 120, and indeed answers provided from the LLM 122 can also be embedded and added to the data store, and those answers (as well as data similar to those answers, as per their respective embeddings) can also be used as additional context for future questions as well.

In some example embodiments, the LLM 112 output can include an explanation of errors in provisioning resources.

Additionally, the chatbot 12 can be interacted via chat, voice, and other interfaces.

Referring to FIG. 1, once the user 118 is satisfied with the provisioning plan, they may approve it. At this point the approved provisioning plan is sent to a cloud provisioner 126, which acts to provision the resources that are indicated in the plan at the time(s) indicate in the plan. This may include, for example, sending instructions at specific times to IaaS services requesting resources, with those times being enough in advance to have the resources be available for use by the computer system 104 without delay but not so far in advance that the resources are left idling for too long, which adds unnecessary cost.

Essentially, the cloud provisioner 126 takes the provisioning plan and understands how it works with respect to the resources in the hyperscaler, and therefore turns those plans into a sequence of requests, adding in delays when needed.

A machine learning algorithm 124 trains the machine learning model 112 to predict short-and long-term usage patterns for the computer system 104.

The machine learning algorithm 124 utilizes training data 128, which comprises historical time series data of past usage. This time series data can contain many different features. Any features present in the time series data, or other training data 128, can potentially be a predictive feature of usage patterns. For example, if the training data 128 data is broken down at the individual user level, then the machine learning model 112 can be trained to make usage pattern predictions for individual users.

Specifically, the machine learning model 112 may be trained by any algorithm from among many different potential supervised or unsupervised machine learning algorithms. Examples of supervised learning algorithms include artificial neural networks, Bayesian networks, instance-based learning, support vector machines, linear classifiers, quadratic classifiers, k-nearest neighbors, decision trees, and hidden Markov models.

In an example embodiment, a machine learning algorithm 124 used to train a machine learning model 112 may iterate among various weights (which are the parameters) that will be multiplied by various input variables and evaluate a loss function at each iteration, until the loss function is minimized, at which stage the weights/parameters for that stage are learned. Specifically, the weights are multiplied by the input variables as part of a weighted sum operation, and the weighted sum operation is used by the loss function.

In some example embodiments, the training of these machine learning models 112 may take place as a dedicated training phase. In other example embodiments, the machine learning models 112 may be retrained dynamically at runtime based on, for example, developer or user feedback.

In some example embodiments, the machine learning model 112 is a neural network optimized for time series predictions. One such neural network model is the LSTM model, which can be utilized here in addition to being used for the Gen AI aspects.

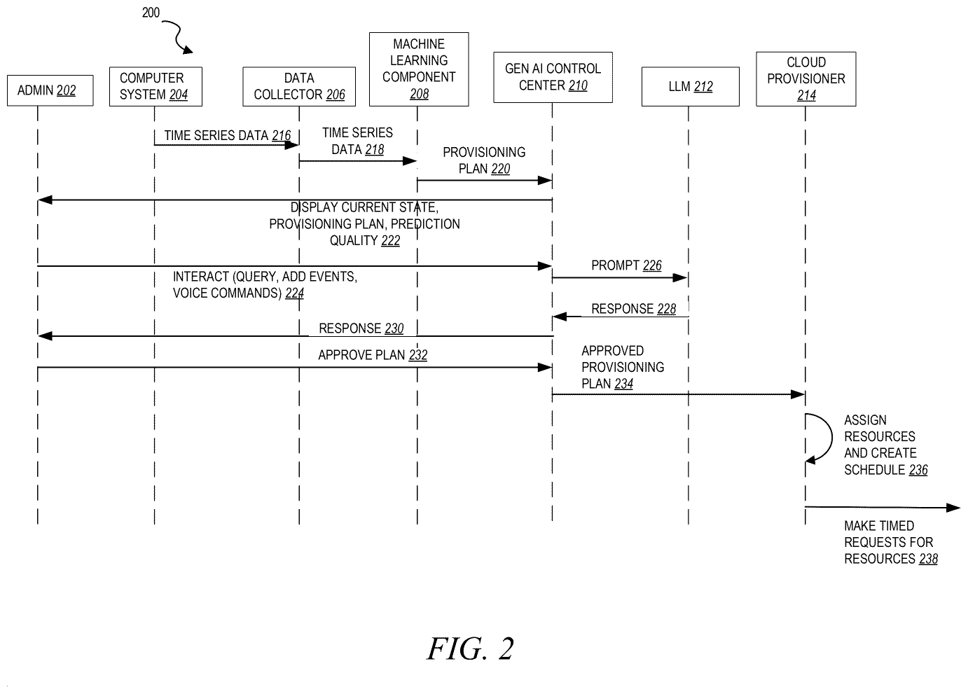

FIG. 2 is a sequence diagram illustrating a method 200 for provisioning resources in a networked system, in accordance with an example embodiment. The method 200 utilizes an admin 202, a computer system 204, a data collector 206, a machine learning component 208, a Gen AI control center 210, and LLM 212, and a cloud provisioner 214.

At operation 216, time series data is collected by the data collector 206 from the computer system 204. At operation 218, this time series data is passed to the machine learning component 208. At operation 220, the machine learning component creates a provisioning plan based on output of a machine learning model and passes the provisioning plan to the Gen AI control center 210. At operation 222, the Gen AI control center 210 causes display to the admin 202 of the current state of the computer system 204, the provisioning plan, and information about the prediction quality (which may be calculated, for example, from intermediate results from the machine learning model or other processes within the machine learning component 208). At operation 224 the admin 202 interacts with the Gen AI control center 210, such as by submitting a query in a chatbot, adding an event, or using voice commands.

Based on this interaction, at operation 226 the Gen AI control center 210 generates a prompt and sends the prompt to the LLM 212, which responds at operation 228. This response may then be displayed to the admin at operation 230. While not pictured here, this cycle of interaction and response can continue any number of different times, until the admin 202 is satisfied with the provisioning plan. At operation 232, the admin approves the provisioning plan. At operation 234, the approved provisioning plan is sent to a cloud provisioner 214.

At operation 236, the cloud provisioner assigns resources and creates a schedule. This schedule may include, for example, delays between when resources should be allocated. At the appropriate times, timed requests for resources are then sent to the resource provider at operation 238, such as an IaaS service/hyperscaler. The cloud provisioner is also able to acknowledge that the time needed to prepare the resources can also be changing, and the cloud provisioner is able to consider this when creating the provisioning. Thus, this resource preparation time is not fixed and the cloud provisioner takes this into consideration.

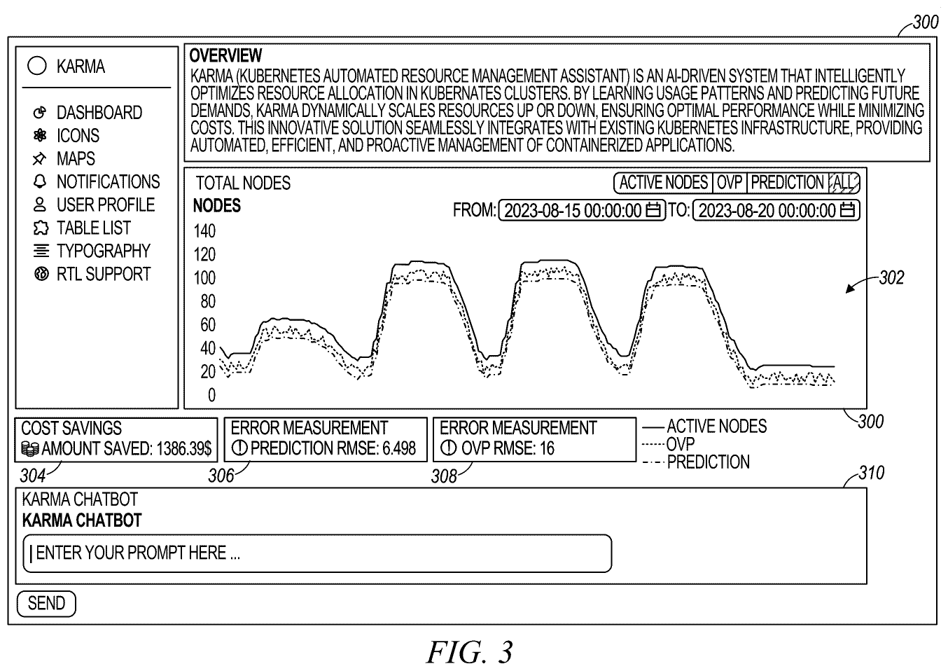

The visualizations presented to the admin 202 can take many forms. FIGS. 3-5 depict examples of one form they can take. FIG. 3 is a screen capture showing a first screen 300 of a user interface, in accordance with an example embodiment. Here, the first screen 300 contains a graphical portion 302 containing a graph showing the provisioning plan in comparison to active nodes and predicted nodes needed, over time. Here, the nodes represent the resources.

Also displayed are some metrics relevant to the admin 202. Specifically, a cost savings portion 304 where a prediction of the cost savings to the admin's organization if the provisioning plan is implemented is displayed. Also, a prediction root mean squared error (RMSE) 306 is depicted, showing the uncertainty in the prediction, as well as a prediction RMSE 308. It should be noted that RMSE is merely one example of a metric showcasing the accuracy of the model. Other metrics can be used in addition to, or in lieu of, RMSE. A chatbot 310 is provided where a user can enter a query.

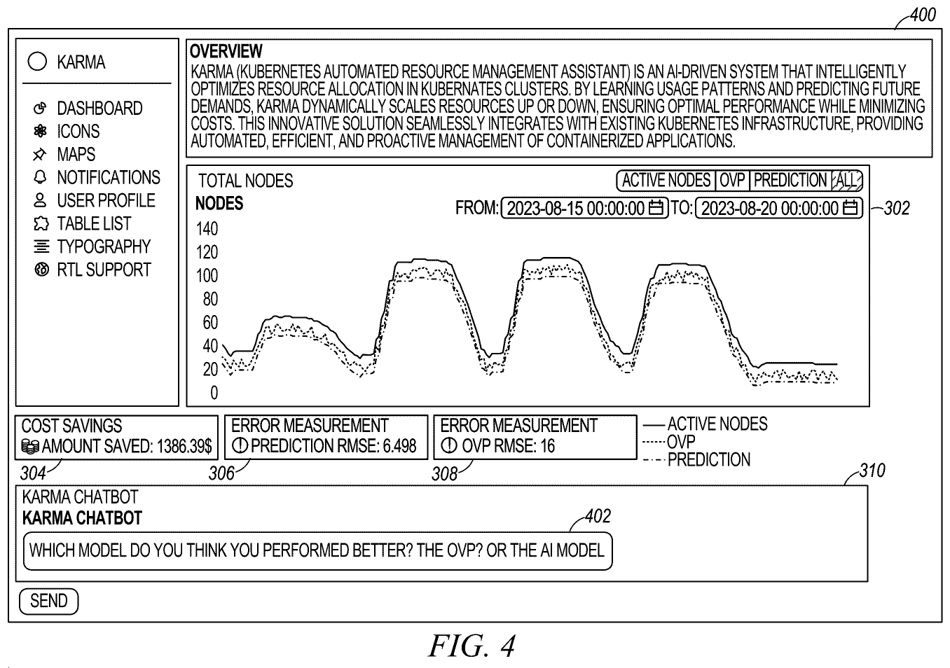

FIG. 4 is a screen capture showing a second screen 400 of the user interface, in accordance with an example embodiment. Here, the admin 202 has entered text 402 in the chatbot 310. The text 402 represents a query, which is then incorporated into a prompt to an LLM to generate a response.

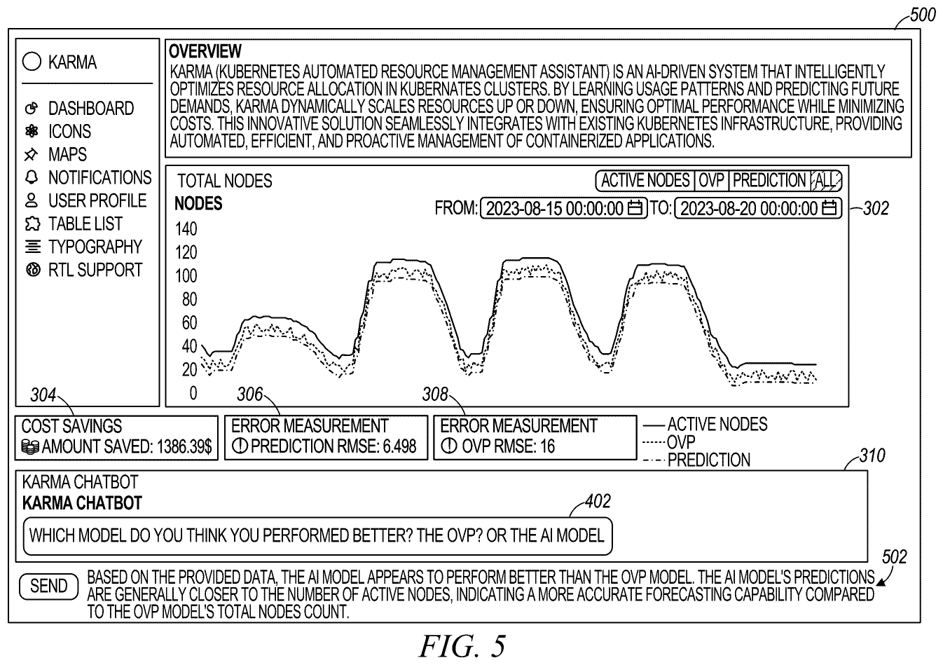

FIG. 5 is a screen capture showing a third screen 500 of the user interface, in accordance with an example embodiment. Here, the response 502 is displayed to the admin 202.

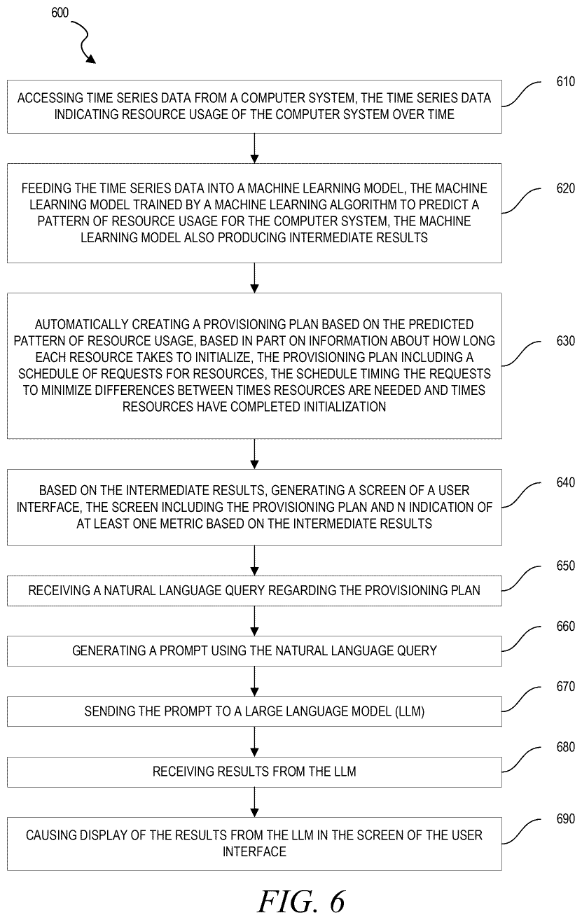

FIG. 6 is a flow diagram illustrating a method 600, in accordance with an example embodiment.

At operation 610, time series data from a computer system is accessed. The time series data indicates resource usage of the computer system over time]

At operation 620, the time series data is fed into a machine learning model. The machine learning model is trained by a machine learning algorithm to predict a pattern of resource usage for the computer system, the machine learning model also producing intermediate results.

At operation 630, a provisioning plan is automatically created based on the predicted pattern of resource usage, based in part on information about how long each resource takes to initialize. The provisioning plan comprises a schedule of requests for resources, the schedule timing the requests to minimize differences between times resources are needed and times resources have completed initialization.

At operation 640, based on the intermediate results, a screen of a user interface is generated. The screen comprises the provisioning plan and an indication of at least one metric based on the intermediate results.

At operation 650, a natural language query regarding the provisioning plan is received.

At operation 660, a prompt is generated using the natural language query.

At operation 670, the prompt is sent to a large language model (LLM). At operation 680, results are received from the LLM. At operation 690, the results from the LLM are caused to be displayed in the screen of the user interface.

In view of the disclosure above, various examples are set forth below. It should be noted that one or more features of an example, taken in isolation or combination, should be considered within the disclosure of this application.

Example 1 is a system comprising: at least one hardware processor; a non-transitory computer-readable medium storing instructions that, when executed by the at least one hardware processor, cause the at least one hardware processor to perform operations comprising: accessing time series data from a computer system, the time series data indicating resource usage of the computer system over time; feeding the time series data into a machine learning model, the machine learning model trained by a machine learning algorithm to predict a pattern of resource usage for the computer system, the machine learning model also producing intermediate results; automatically creating a provisioning plan based on the predicted pattern of resource usage, based in part on information about how long each resource takes to initialize, the provisioning plan comprising a schedule of requests for resources, the schedule timing the requests to minimize differences between times resources are needed and times resources have completed initialization; based on the intermediate results, generating a screen of a user interface, the screen comprising the provisioning plan and an indication of at least one metric based on the intermediate results; receiving a natural language query regarding the provisioning plan; generating a prompt using the natural language query; sending the prompt to a large language model (LLM); receiving results from the LLM; and causing display of the results from the LLM in the screen of the user interface.

In Example 2, the subject matter of Example 1 comprises, wherein the operations further comprise training the machine learning model by passing training data through the machine learning algorithm, the training data comprising historical time series data of resource usage by the computer system.

In Example 3, the subject matter of Example 2 comprises, wherein the machine learning model is trained on a per-tenant basis, where each tenant of the computer system has its own machine learning model trained using training data that is unique to a corresponding tenant.

In Example 4, the subject matter of Examples 2-3 comprises, wherein the machine learning algorithm is a long short-term memory neural network.

In Example 5, the subject matter of Examples 1-4 comprises, wherein the operations further comprise: embedding the natural language query into a first set of embeddings, each embedding representing a set of coordinates in a latent n-dimensional space, using an embedding machine learning model; identifying one or more similar embeddings to embeddings in the first set of embeddings based on distance between the one or more similar embeddings and the embeddings in the first set of embeddings; and adding data corresponding to the one or more similar embeddings to the prompt as context, prior to sending the prompt to the LLM.

In Example 6, the subject matter of Examples 1-5 comprises, wherein the operations further comprise: sending the provisioning plan as part of a prompt to the LLM to generate a graph visually depicting the provisioning plan, and wherein the generating the screen comprises rendering the graph visually on the screen.

In Example 7, the subject matter of Examples 1-6 comprises, wherein the resources are hyperscaler resources.

Example 8 is a method comprising: accessing time series data from a computer system, the time series data indicating resource usage of the computer system over time; feeding the time series data into a machine learning model, the machine learning model trained by a machine learning algorithm to predict a pattern of resource usage for the computer system, the machine learning model also producing intermediate results; automatically creating a provisioning plan based on the predicted pattern of resource usage, based in part on information about how long each resource takes to initialize, the provisioning plan comprising a schedule of requests for resources, the schedule timing the requests to minimize differences between times resources are needed and times resources have completed initialization; based on the intermediate results, generating a screen of a user interface, the screen comprising the provisioning plan and an indication of at least one metric based on the intermediate results; receiving a natural language query regarding the provisioning plan; generating a prompt using the natural language query; sending the prompt to a large language model (LLM); receiving results from the LLM; and causing display of the results from the LLM in the screen of the user interface.

In Example 9, the subject matter of Example 8 comprises, training the machine learning model by passing training data through the machine learning algorithm, the training data comprising historical time series data of resource usage by the computer system.

In Example 10, the subject matter of Example 9 comprises, wherein the machine learning model is trained on a per-tenant basis, where each tenant of the computer system has its own machine learning model trained using training data that is unique to a corresponding tenant.

In Example 11, the subject matter of Examples 9-10 comprises, wherein the machine learning algorithm is a long short-term memory neural network.

In Example 12, the subject matter of Examples 8-11 comprises, embedding the natural language query into a first set of embeddings, each embedding representing a set of coordinates in a latent n-dimensional space, using an embedding machine learning model; identifying one or more similar embeddings to embeddings in the first set of embeddings based on distance between the one or more similar embeddings and the embeddings in the first set of embeddings; and adding data corresponding to the one or more similar embeddings to the prompt as context, prior to sending the prompt to the LLM.

In Example 13, the subject matter of Examples 8-12 comprises, sending the provisioning plan as part of a prompt to the LLM to generate a graph visually depicting the provisioning plan, and wherein the generating the screen comprises rendering the graph visually on the screen.

In Example 14, the subject matter of Examples 8-13 comprises, wherein the resources are hyperscaler resources.

Example 15 is a non-transitory machine-readable medium storing instructions which, when executed by one or more processors, cause the one or more processors to perform operations comprising: accessing time series data from a computer system, the time series data indicating resource usage of the computer system over time; feeding the time series data into a machine learning model, the machine learning model trained by a machine learning algorithm to predict a pattern of resource usage for the computer system, the machine learning model also producing intermediate results; automatically creating a provisioning plan based on the predicted pattern of resource usage, based in part on information about how long each resource takes to initialize, the provisioning plan comprising a schedule of requests for resources, the schedule timing the requests to minimize differences between times resources are needed and times resources have completed initialization; based on the intermediate results, generating a screen of a user interface, the screen comprising the provisioning plan and an indication of at least one metric based on the intermediate results; receiving a natural language query regarding the provisioning plan; generating a prompt using the natural language query; sending the prompt to a large language model (LLM); receiving results from the LLM; and causing display of the results from the LLM in the screen of the user interface.

In Example 16, the subject matter of Example 15 comprises, wherein the operations further comprise training the machine learning model by passing training data through the machine learning algorithm, the training data comprising historical time series data of resource usage by the computer system.

In Example 17, the subject matter of Example 16 comprises, wherein the machine learning model is trained on a per-tenant basis, where each tenant of the computer system has its own machine learning model trained using training data that is unique to a corresponding tenant.

In Example 18, the subject matter of Examples 16-17 comprises, wherein the machine learning algorithm is a long short-term memory neural network.

In Example 19, the subject matter of Examples 15-18 comprises, wherein the operations further comprise: embedding the natural language query into a first set of embeddings, each embedding representing a set of coordinates in a latent n-dimensional space, using an embedding machine learning model; identifying one or more similar embeddings to embeddings in the first set of embeddings based on a distance between the one or more similar embeddings and the embeddings in the first set of embeddings; and adding data corresponding to the one or more similar embeddings to the prompt as context, prior to sending the prompt to the LLM.

In Example 20, the subject matter of Examples 15-19 comprises, wherein the operations further comprise: sending the provisioning plan as part of a prompt to the LLM to generate a graph visually depicting the provisioning plan, and wherein the generating the screen comprises rendering the graph visually on the screen.

Example 21 is at least one machine-readable medium comprising instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

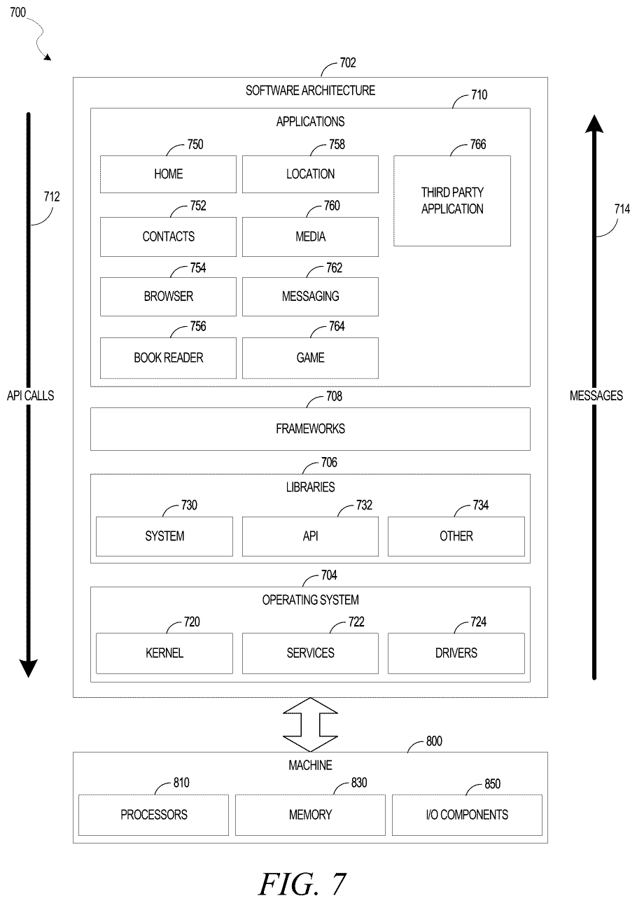

FIG. 7 is a block diagram 700 illustrating a software architecture 702, which can be installed on any one or more of the devices described above.

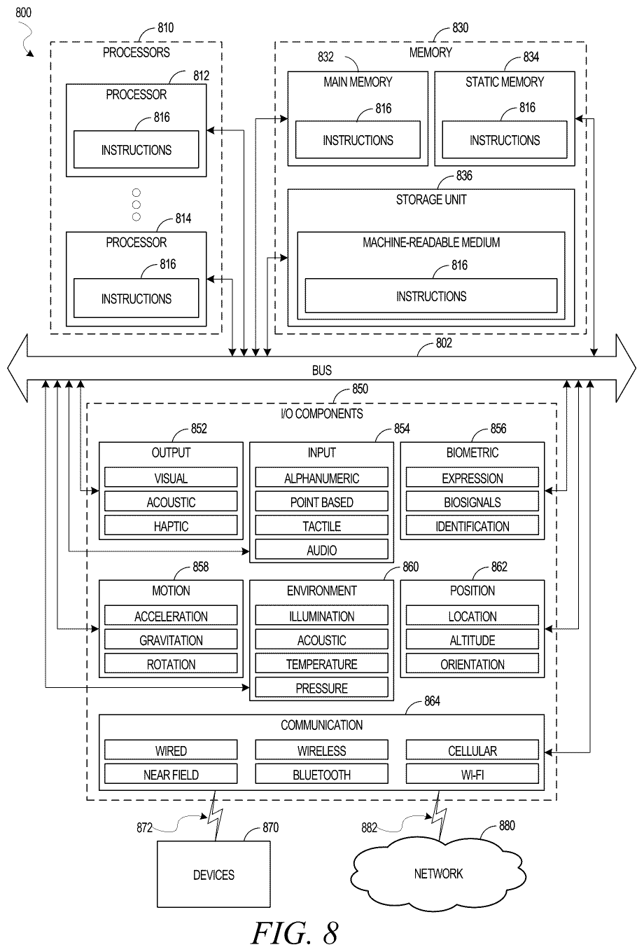

FIG. 7 is merely a non-limiting example of a software architecture, and it will be appreciated that many other architectures can be implemented to facilitate the functionality described herein. In various embodiments, the software architecture 702 is implemented by hardware such as a machine 800 of FIG. 8 that comprises processors 810, memory 830, and input/output (I/O) components 850. In this example architecture, the software architecture 702 can be conceptualized as a stack of layers where each layer may provide a particular functionality. For example, the software architecture 702 comprises layers such as an operating system 704, libraries 706, frameworks 708, and applications 710. Operationally, the applications 710 invoke API calls 712 through the software stack and receive messages 714 in response to the API calls 712, consistent with some embodiments.

In various implementations, the operating system 704 manages hardware resources and provides common services. The operating system 704 comprises, for example, a kernel 720, services 722, and drivers 724. The kernel 720 acts as an abstraction layer between the hardware and the other software layers, consistent with some embodiments. For example, the kernel 720 provides memory management, processor management (e.g., scheduling), component management, networking, and security settings, among other functionalities. The services 722 can provide other common services for the other software layers. The drivers 724 are responsible for controlling or interfacing with the underlying hardware, according to some embodiments. For instance, the drivers 724 can comprise display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 706 provide a low-level common infrastructure utilized by the applications 710. The libraries 706 can comprise system libraries 730 (e.g., C standard library) that can provide functions such as memory allocation functions, string manipulation functions, mathematic functions, and the like. In addition, the libraries 706 can comprise API libraries 732 such as media libraries (e.g., libraries to support presentation and manipulation of various media formats such as Moving Picture Experts Group-4 [MPEG4], Advanced Video Coding [H.264 or AVC], Moving Picture Experts Group Layer-3 [MP3], Advanced Audio Coding [AAC], Adaptive Multi-Rate [AMR] audio codec, Joint Photographic Experts Group [JPEG or JPG], or Portable Network Graphics [PNG]), graphics libraries (e.g., an OpenGL framework used to render in two dimensions [2D] and three dimensions [3D] in a graphic context on a display), database libraries (e.g., SQLite to provide various relational database functions), web libraries (e.g., WebKit to provide web browsing functionality), and the like. The libraries 706 can also comprise a wide variety of other libraries 734 to provide many other APIs to the applications 710.

The frameworks 708 provide a high-level common infrastructure that can be utilized by the applications 710, according to some embodiments. For example, the frameworks 708 provide various GUI functions, high-level resource management, high-level location services, and so forth. The frameworks 708 can provide a broad spectrum of other APIs that can be utilized by the applications 710, some of which may be specific to a particular operating system 704 or platform.

In an example embodiment, the applications 710 comprise a home application 750, a contacts application 752, a browser application 754, a book reader application 756, a location application 758, a media application 760, a messaging application 762, a game application 764, and a broad assortment of other applications, such as a third-party application 766. According to some embodiments, the applications 710 are programs that execute functions defined in the programs. Various programming languages can be employed to create one or more of the applications 710, structured in a variety of manners, such as object-oriented programming languages (e.g., Objective-C, Java, or C++) or procedural programming languages (e.g., C or assembly language). In a specific example, the third-party application 766 (e.g., an application developed using the ANDROID™ or IOS™ software development kit (SDK) by an entity other than the vendor of the platform) may be mobile software running on a mobile operating system such as IOS™, ANDROID™, WINDOWS® Phone, or another mobile operating system. In this example, the third-party application 766 can invoke the API calls 712 provided by the operating system 704 to facilitate functionality described herein.

FIG. 8 illustrates a diagrammatic representation of a machine 800 in the form of a computer system within which a set of instructions may be executed for causing the machine 800 to perform any one or more of the methodologies discussed herein, according to an example embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the method 600 of FIG. 6. Additionally, or alternatively, the instructions 816 may implement FIGS. 1-6 and so forth. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 816, sequentially or otherwise, that specify actions to be taken by the machine 800.

Further, while only a single machine 800 is illustrated, the term “machine” shall also be taken to comprise a collection of machines 800 that individually or jointly execute the instructions 816 to perform any one or more of the methodologies discussed herein.

The machine 800 may comprise processors 810, memory 830, and I/O components 850, which may be configured to communicate with each other such as via a bus 802. In an example embodiment, the processors 810 (e.g., a central processing unit [CPU], a reduced instruction set computing [RISC] processor, a complex instruction set computing [CISC] processor, a graphics processing unit [GPU], a digital signal processor [DSP], an application-specific integrated circuit [ASIC], a radio-frequency integrated circuit [RFIC], another processor, or any suitable combination thereof) may comprise, for example, a processor 812 and a processor 814 that may execute the instructions 816. The term “processor” is intended to comprise multi-core processors that may comprise two or more independent processors (sometimes referred to as “cores”) that may execute instructions 816 contemporaneously. Although FIG. 8 shows multiple processors 810, the machine 800 may comprise a single processor 812 with a single core, a single processor 812 with multiple cores (e.g., a multi-core processor 812), multiple processors 812, 814 with a single core, multiple processors 812, 814 with multiple cores, or any combination thereof.

The memory 830 may comprise a main memory 832, a static memory 834, and a storage unit 836, each accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may comprise a wide variety of components to receive input, provide output, produce output, transmit information, exchange information, capture measurements, and so on. The specific I/O components 850 that are comprised in a particular machine will depend on the type of machine. For example, portable machines such as mobile phones will likely comprise a touch input device or other such input mechanisms, while a headless server machine will likely not comprise such a touch input device. It will be appreciated that the I/O components 850 may comprise many other components that are not shown in FIG. 8. The I/O components 850 are grouped according to functionality merely for simplifying the following discussion, and the grouping is in no way limiting. In various example embodiments, the I/O components 850 may comprise output components 852 and input components 854. The output components 852 may comprise visual components (e.g., a display such as a plasma display panel [PDP], a light-emitting diode [LED] display, a liquid crystal display [LCD], a projector, or a cathode ray tube [CRT]), acoustic components (e.g., speakers), haptic components (e.g., a vibratory motor, resistance mechanisms), other signal generators, and so forth. The input components 854 may comprise alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 850 may comprise biometric components 856, motion components 858, environmental components 860, or position components 862, among a wide array of other components. For example, the biometric components 856 may comprise components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, fingerprint identification, or electroencephalogram-based identification), and the like. The motion components 858 may comprise acceleration sensor components (e.g., accelerometer), gravitation sensor components, rotation sensor components (e.g., gyroscope), and so forth. The environmental components 860 may comprise, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may comprise location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may comprise communication components 864 operable to couple the machine 800 to a network 880 or devices 870 via a coupling 882 and a coupling 872, respectively. For example, the communication components 864 may comprise a network interface component or another suitable device to interface with the network 880. In further examples, the communication components 864 may comprise wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., coupled via a USB).

Moreover, the communication components 864 may detect identifiers or comprise components operable to detect identifiers. For example, the communication components 864 may comprise radio-frequency identification (RFID) tag reader components, NFC smart tag detection components, optical reader components (e.g., an optical sensor to detect one-dimensional bar codes such as Universal Product Code [UPC] bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

The various memories (e.g., 830, 832, 834, and/or memory of the processor[s] 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to comprise, but not be limited to, solid-state memories, and optical and magnetic media, comprising memory internal or external to processors. Specific examples of machine-storage media, computer-storage media, and/or device-storage media comprise non-volatile memory, comprising by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium”discussed below.

In various example embodiments, one or more portions of the network 880 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may comprise a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) comprising 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 816 may be transmitted or received over the network 880 using a transmission medium via a network interface device (e.g., a network interface component comprised in the communication components 864) and utilizing any one of a number of well-known transfer protocols (e.g., HTTP).

Similarly, the instructions 816 may be transmitted or received using a transmission medium via the coupling 872 (e.g., a peer-to-peer coupling) to the devices 870. The terms “transmission medium” and “signal medium” mean the same thing and may be used interchangeably in this disclosure. The terms “transmission medium” and “signal medium” shall be taken to comprise any intangible medium that is capable of storing, encoding, or carrying the instructions 816 for execution by the machine 800, and comprise digital or analog communications signals or other intangible media to facilitate communication of such software. Hence, the terms “transmission medium” and “signal medium” shall be taken to comprise any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to comprise both machine-storage media and transmission media. Thus, the terms comprise both storage devices/media and carrier waves/modulated data signals.

What is claimed is:

1. A system comprising:
at least one hardware processor;
a non-transitory computer-readable medium storing instructions that, when executed by the at least one hardware processor, cause the at least one hardware processor to perform operations comprising:
accessing time series data from a computer system, the time series data indicating resource usage of the computer system over time;
feeding the time series data into a machine learning model, the machine learning model trained by a machine learning algorithm to predict a pattern of resource usage for the computer system, the machine learning model producing intermediate results;
automatically creating a provisioning plan based on the predicted pattern of resource usage, based in part on information about how long each resource takes to initialize, the provisioning plan comprising a schedule of requests for resources, the requests being timed within the schedule to reduce differences between times resources are needed and times resources have completed initialization;
based on the intermediate results, generating a screen of a user interface, the screen comprising the provisioning plan and an indication of at least one metric based on the intermediate results;
receiving a natural language query regarding the provisioning plan;
generating a prompt using the natural language query;
sending the prompt to a large language model (LLM);
receiving results from the LLM; and
causing display of the results from the LLM in the screen of the user interface.

2. The system of claim 1, wherein the operations further comprise training the machine learning model by passing training data through the machine learning algorithm, the training data comprising historical time series data of resource usage by the computer system.

3. The system of claim 2, wherein the machine learning model is trained on a per-tenant basis, where each tenant of the computer system has its own machine learning model trained using training data that is unique to a corresponding tenant.

4. The system of claim 2, wherein the machine learning algorithm is a long short-term memory neural network.

5. The system of claim 1, wherein the operations further comprise:
embedding the natural language query into a first set of embeddings, each embedding representing a set of coordinates in a latent n-dimensional space, using an embedding machine learning model;
identifying one or more similar embeddings to embeddings in the first set of embeddings based on distance between the one or more similar embeddings and the embeddings in the first set of embeddings; and
adding data corresponding to the one or more similar embeddings to the prompt as context, prior to sending the prompt to the LLM.

6. The system of claim 1, wherein the operations further comprise:
sending the provisioning plan as part of a prompt to the LLM to generate a graph visually depicting the provisioning plan, and wherein the generating the screen comprises rendering the graph visually on the screen.

7. The system of claim 1, wherein the resources are hyperscaler resources.

8. A method comprising:
accessing time series data from a computer system, the time series data indicating resource usage of the computer system over time;
feeding the time series data into a machine learning model, the machine learning model trained by a machine learning algorithm to predict a pattern of resource usage for the computer system, the machine learning model producing intermediate results;
automatically creating a provisioning plan based on the predicted pattern of resource usage, based in part on information about how long each resource takes to initialize, the provisioning plan comprising a schedule of requests for resources, the requests being timed within the schedule to reduce differences between times resources are needed and times resources have completed initialization;
based on the intermediate results, generating a screen of a user interface, the screen comprising the provisioning plan and an indication of at least one metric based on the intermediate results;
receiving a natural language query regarding the provisioning plan;
generating a prompt using the natural language query;
sending the prompt to a large language model (LLM);
receiving results from the LLM; and
causing display of the results from the LLM in the screen of the user interface.

9. The method of claim 8, further comprising training the machine learning model by passing training data through the machine learning algorithm, the training data comprising historical time series data of resource usage by the computer system.

10. The method of claim 9, wherein the machine learning model is trained on a per-tenant basis, where each tenant of the computer system has its own machine learning model trained using training data that is unique to a corresponding tenant.

11. The method of claim 9, wherein the machine learning algorithm is a long short-term memory neural network.

12. The method of claim 8, further comprising:
embedding the natural language query into a first set of embeddings, each embedding representing a set of coordinates in a latent n-dimensional space, using an embedding machine learning model;
identifying one or more similar embeddings to embeddings in the first set of embeddings based on distance between the one or more similar embeddings and the embeddings in the first set of embeddings; and
adding data corresponding to the one or more similar embeddings to the prompt as context, prior to sending the prompt to the LLM.

13. The method of claim 8, further comprising:
sending the provisioning plan as part of a prompt to the LLM to generate a graph visually depicting the provisioning plan, and wherein the generating the screen comprises rendering the graph visually on the screen.

14. The method of claim 8, wherein the resources are hyperscaler resources.

15. A non-transitory machine-readable medium storing instructions which, when executed by one or more processors, cause the one or more processors to perform operations comprising:
accessing time series data from a computer system, the time series data indicating resource usage of the computer system over time;
feeding the time series data into a machine learning model, the machine learning model trained by a machine learning algorithm to predict a pattern of resource usage for the computer system, the machine learning model producing intermediate results;
automatically creating a provisioning plan based on the predicted pattern of resource usage, based in part on information about how long each resource takes to initialize, the provisioning plan comprising a schedule of requests for resources, the requests being timed within the schedule to reduce differences between times resources are needed and times resources have completed initialization;
based on the intermediate results, generating a screen of a user interface, the screen comprising the provisioning plan and an indication of at least one metric based on the intermediate results;
receiving a natural language query regarding the provisioning plan;
generating a prompt using the natural language query;
sending the prompt to a large language model (LLM);
receiving results from the LLM; and
causing display of the results from the LLM in the screen of the user interface.

16. The non-transitory machine-readable medium of claim 15, wherein the operations further comprise training the machine learning model by passing training data through the machine learning algorithm, the training data comprising historical time series data of resource usage by the computer system.

17. The non-transitory machine-readable medium of claim 16, wherein the machine learning model is trained on a per-tenant basis, where each tenant of the computer system has its own machine learning model trained using training data that is unique to a corresponding tenant.

18. The non-transitory machine-readable medium of claim 16, wherein the machine learning algorithm is a long short-term memory neural network.

19. The non-transitory machine-readable medium of claim 15, wherein the operations further comprise:
embedding the natural language query into a first set of embeddings, each embedding representing a set of coordinates in a latent n-dimensional space, using an embedding machine learning model;
identifying one or more similar embeddings to embeddings in the first set of embeddings based on distance between the one or more similar embeddings and the embeddings in the first set of embeddings; and
adding data corresponding to the one or more similar embeddings to the prompt as context, prior to sending the prompt to the LLM.

20. The non-transitory machine-readable medium of claim 15, wherein the operations further comprise:
sending the provisioning plan as part of a prompt to the LLM to generate a graph visually depicting the provisioning plan, and wherein the generating the screen comprises rendering the graph visually on the screen.
